(19) United States
(12) Patent Application Publication
(10) Pub. No.: US 2010/0153258 A1
(43) Pub. Date: Jun. 17, 2010

(54) SYSTEM AND METHOD FOR SECURING A LETTER OF CREDIT THROUGH HEDGING OF DERIVATIVES

(75) Inventors: Sumit Aggarwal, Oliva Block (SG); Gabriel Mau Chi Sham, The Mayfair (SG)

Correspondence Address: SNELL & WILMER L.L.P. (Main), 400 EAST VAN BUREN, ONE ARIZONA CENTER, PHOENIX, AZ, 85004-2202, US

(73) Assignee: STANDARD CHARTERED BANK, London (GB)

(21) Appl. No.: 12/350,494

(22) Filed: Jan. 8, 2009

(30) Foreign Application Priority Data
Dec. 16, 2008 (SG) 200809364-3

(51) Int. Cl. G06Q 40/00

(52) U.S. Cl. 705/38

(57) ABSTRACT

Transforming hedging information and Forced Sale Value (FSV) information to a special LC and to a reduction in an applicant's booked credit limit and a reduced risk weighted asset (RWA), along with eliminating or reducing price risk and enabling a financial institution to determine its potential loss upon default, is disclosed. The disclosed LC is obtained through application, in relation to shipment of a commodity and the commodity is hedged against price risk by the issuing financial institution. The issuing financial institution also determines a FSV for the commodity. Thus, the issuing financial institution determines what the commodity would sell for, regardless of price movements, should the buyer not follow through with payment and a forced sale becomes necessary.

### CROSS-REFERENCE TO RELATED APPLICATIONS

This application claims the right of priority based on Singapore Patent Application No. 200809364-3 entitled “SYSTEM AND METHOD FOR SECURING A LETTER OF CREDIT THROUGH HEDGING OF DERIVATIVES,” filed on Dec. 16, 2008, which is incorporated herein by reference and assigned to the assignee herein.

### BACKGROUND OF THE INVENTION

A letter of credit (LC) is widely used in the commodities trade for buyers to settle trade payment obligations with suppliers. An LC issued by a financial institution (e.g., bank) constitutes an irrevocable undertaking to the beneficiary (e.g., supplier), in which the financial institution (e.g., issuing bank) undertakes to make payment to the beneficiary contingent on the beneficiary's compliance with the terms and conditions of the LC. On issuing the LC, the issuing bank incurs a contingent obligation that is recorded against the applicant's credit limit. Depending on the documentary conditions of the LC, the issuing bank may or may not have control of the underlying goods. Where the issuing bank has control of the underlying goods through the documents, an LC is booked as a “secured LC”. Otherwise it is booked as an “unsecured LC.”

Conventionally, the issuing financial institution (e.g., issuing bank) performs a credit risk analysis in light of the applicant's credit worthiness and establishes a line of credit for the applicant. The following exemplary steps describe a typical LC issuance and drawing process:
1. When the applicant submits an LC application, the issuing financial institution determines whether the applicant has a sufficient line of credit relative to the requested LC, issues the LC, recorded against the applicant's credit limit, and transmits the LC to an advising bank.
2. Upon receipt of the LC, the advising bank advises the LC to the beneficiary.
3. The beneficiary delivers goods to a carrier for shipment to the applicant.
4. The carrier issues full set Bill of Lading (B/L) to the beneficiary.
5. The beneficiary presents complying documents, including full set B/L, to the presenting bank.
6. The presenting bank forwards complying documents to the issuing financial institution for payment under LC.
7. The issuing financial institution facilitates payment in the amount defined by the LC to the presenting bank, for payment to the beneficiary.
8. Concurrently the applicant reimburses the issuing financial institution for the amount of the drawing.
9. Upon reimbursement by the applicant, the issuing financial institution releases documents (including full set B/L) to the applicant.
10. The applicant presents the B/L to the carrier for delivery of goods, and the carrier releases the goods to the applicant against the B/L.

A secured LC enables the issuing financial institution to control the goods through the B/L. The issuing financial institution transfers control of the goods to the applicant, when the B/L is released to the applicant upon reimbursement by the applicant of the amount of the drawing. A secured LC is considered to be a highly secure instrument because the issuing financial institution is in a position to dispose of the goods in the event the applicant fails to reimburse the issuing financial institution. Thus, while steps 1 to 7 above remain the same or similar, exemplary steps 8 to 10 are as follows:
8. The applicant fails to reimburse the issuing financial institution for the amount of the drawing, in which case the issuing financial institution initiates a sales agreement with a new buyer.
9. The issuing financial institution transfers control of the goods to the new buyer by releasing the B/L to the new buyer.
10. The new buyer presents the B/L to the carrier for delivery of goods, and the carrier releases the goods to the new buyer against the B/L.

The secured LC calls for a full set of the original on board B/L, which is issued to order of the issuing financial institution, or endorsed in blank or to order of the issuing financial institution. The goods are insured by the applicant against the risk of loss or damage during carriage, unless the International Commercial Term (Incoterm) is Cost Insurance and Freight (CIF) or Carriage and Insurance Paid (CIP), in which case the LC will call for an insurance policy. Incoterms refer to a series of international sales terms widely used throughout the world, which are used to divide transaction costs and responsibilities between buyer and seller. The Incoterms closely correspond to the United Nations Convention on Contracts for the International Sale of Goods.)

While a secured LC provides a degree of protection against loss to the issuing financial institution, additional financial risks often remain relating to losses due to fluctuations in the market value of the secured goods and costs associated with the storage, transport, and sale of the goods to a new buyer. As such, prior methods for issuing the LC generally require that the applicant's line of credit be recorded for the full amount of the LC.

Notably it is a widely adopted practice for applicants of LCs covering the purchase of commodities to hedge against price risks, on their own accord, by means of commodity derivatives such as, for example, forward contracts or options.

Therefore, a need exists for a system and method that allows an issuing financial institution to reduce risk associated with issuing LCs, for which the price risk is hedged through the issuing financial institution by means of commodity derivatives, thereby allowing the issuing financial institution to record its exposure under the LC according to the potential costs associated with the sales and delivery of the goods to a new buyer in the event the applicant fails to reimburse the issuing financial institution for payment under the LC.

### BRIEF DESCRIPTION OF THE DRAWINGS

A more complete understanding of the invention may be derived by referring to the detailed description when considered in connection with the Figures, wherein like reference numbers refer to similar elements throughout the Figures, and:

FIG. 1 is an overview of an exemplary system for interacting with various parties to create the disclosed LC and ensure compliance with terms of the hedged LC, in accordance with various embodiments of the present invention;

FIG. 2 is a process flow diagram showing an exemplary process for issuing a hedged LC and managing execution of the LC, in accordance with various embodiments of the present invention; and,

FIG. 3 is a combination system diagram and process flow diagram showing exemplary components and processes for issuing a hedged LC and managing execution of the LC, in accordance with various embodiments of the present invention.

### SUMMARY OF THE INVENTION

The system and method is directed toward transforming hedging information and Forced Sale Value (FSV) information to a special LC and to a reduction in an applicant's booked credit limit, along with a reduced risk weighted asset (RWA), along with eliminating or reducing price risk and enabling a financial institution to determine its potential loss upon default. The disclosed LC is obtained through application, in relation to shipment of a commodity. In one embodiment, the commodity is hedged against price risk by the issuing financial institution. The issuing financial institution also determines a FSV for the commodity. Thus, the issuing financial institution determines what the commodity would sell for, regardless of price movements, should the buyer not follow through with payment and a forced sale becomes necessary.

More specifically, the purchaser's creditworthiness is evaluated and a line of credit is established for the purchaser for the issuance of LC, based largely on the FSV of the hedged commodity. On submitting an LC application to the issuing financial institution, the purchaser requests the issuing bank to hedge the commodity against price risk. Upon hedging of the commodity against price risk, the issuing financial institution issues the LC in favor of the seller (beneficiary). The terms of the sale, negotiated and agreed between the purchaser and the seller, are included in the terms and conditions of the LC as documentary requirements, which are satisfied before funds are paid from the issuing bank to the nominated bank for payment to the seller. Among other things, the LC includes a full set of original on board bills of lading, which confers on the issuing financial institution the title to the goods. If the terms of the LC are subsequently met, the issuing financial institution releases funds to the beneficiary by way of the nominated bank. If the purchaser fails to reimburse the issuing financial institution for the amount paid under the LC, the issuing financial institution takes possession of the goods from the carrier by presenting the original bill of lading and sells the goods to another buyer in order to recover the proceeds. Price loss may then be recovered by way of the hedging mechanism.

In accordance with an embodiment of the present invention, a hedging process may be performed by a Commodity Derivatives Desk of the issuing financial institution, an investment entity of a financial institution, or any other trusted third-party, while LC issuance may be performed by a trade operation department of the financial institution. For example, the entity that performs the hedging process may follow existing processes and procedures for hedging, and then forward a confirmation to the trade operation department, upon which a trade operation department issues the LC to the beneficiary by booking the exposure under the special limit for the hedged LC.

### DETAILED DESCRIPTION OF EXEMPLARY EMBODIMENTS

The detailed description herein is presented for purposes of illustration only and not of limitation. For example, the steps recited in any of the method or process descriptions may be executed in any order and are not limited to the order presented. For the sake of brevity, conventional data networking, application development and other functional aspects of the systems (and components of the individual operating components of the systems) may not be described in detail herein. References to singular include plural, and references to plural include singular.

The system and method allows an issuing financial institution to reduce risk associated with issuing LCs, as well as enabling applicants to qualify for an LC without the need to establish a line of credit for the entire value of the goods and associated costs. Contrary to prior art system and methods for issuing LCs, the present invention transforms information relating to futures markets, commodity, and commodity derivatives to create a unique hedged LC, which reduces or eliminates price risk through hedging the issuing financial institution's potential loss in the event of the applicant's default. With price risk reduced or eliminated, the financial institution's potential loss in response to applicant's default can be determined using the FSV. The FSV is accomplished by taking into account costs associated with selling and delivering the goods to a new buyer, among other potential costs associated with the goods. For example, assuming the costs associated with selling and delivering the goods to a new buyer is 20% of the goods value, the financial institution's risk exposure to the applicant is 20% of the goods value for issuing a LC. In accordance with the present invention, the recording of the applicant's credit limit is accordingly reduced to 20% of the LC amount.

The present invention overcomes the disadvantages of the prior art by establishing a safeguard against market fluctuations of prices of the goods that are subject to a LC. This is particularly important to the trade of goods that are considered commodities, which are subject to worldwide and/or local market fluctuations. For example, under the prior art, a bank may issue a secured LC for a purchaser for the purchase of 10,000 barrels of oil. The negotiated purchase price between the purchaser and seller is $85 US per barrel. Therefore, under the prior art, the issuing bank determines whether the risk associated with issuing the LC in the amount of $850,000 is mitigated by the creditworthiness of the applicant for the LC (purchaser). Based on the applicant's creditworthiness, the issuing bank may issue a line of credit to the applicant in the amount of approximately $850,000. If during a time between the issuance of the LC and the delivery of the oil, oil falls to $65 per barrel, a shortfall may exist. If the purchaser does not follow through on the agreement to purchase the oil, then the issuing bank may now only be able to sell the oil to another buyer for $650,000, and the issuing bank would lose $200,000 as a result of the transaction.

In contrast, using the present invention, in one embodiment, the issuing bank uses a hedging mechanism for hedging the price of the underlying oil through a commodity derivative. The issuing bank may then sell the underlying goods to a new buyer and any shortfall in the price is covered by the hedge. As such, the $200,000 price loss risk is eliminated or reduced. The issuing bank also determines its potential loss in the event of applicant's default by calculating the FSV for the oil which may be $170,000 (20% of the original price) for storage, insurance, shipping, etc. The issuing bank may then book the applicant's credit limit as $170,000, along with a reduced RWA.

In one embodiment, a Documentary Trade Port System and a Limit Trade System may be constituents of the issuing financial institution (e.g., trade finance processing system). Moreover, a special limit for the disclosed hedged LC may be designated within the Limit Trade Port System for a particular LC applicant. Such a special limit may take into consideration the FSV of the hedged commodity and the issuance of the hedged LC for the applicant may be booked under the special limit.

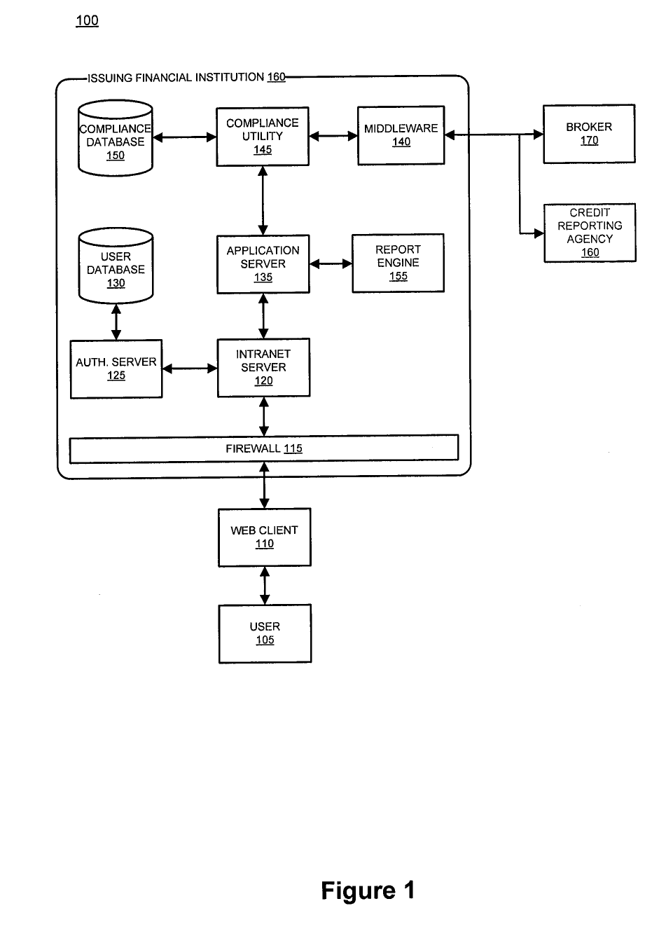

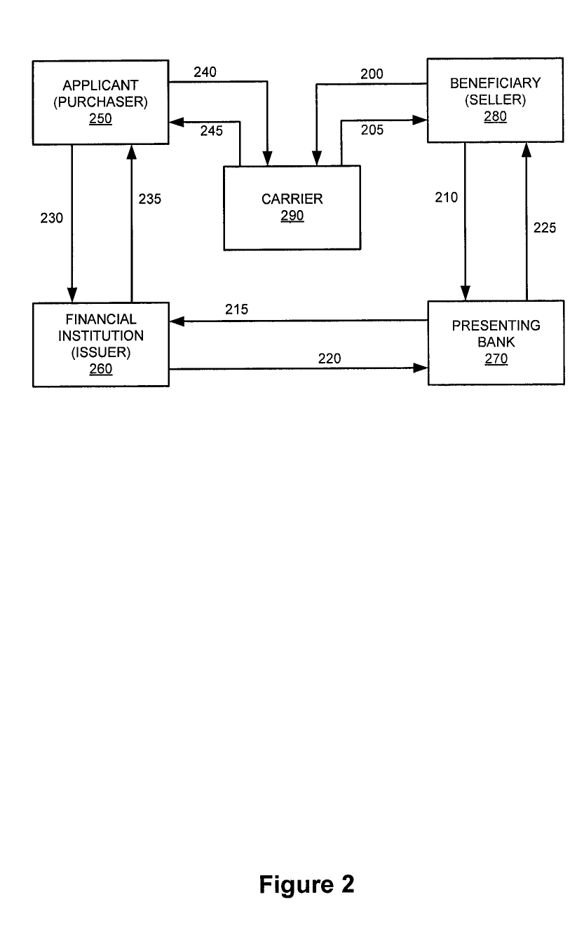

With reference to FIG. 1, system 100 of the present invention may include, in one embodiment, a financial institution 160 (e.g., issuing financial institution), broker 170, credit reporting agency 160, web client 110, and user 105. Issuing financial institution 160 may include, in one embodiment, firewall 115, intranet server 120, authorization server 125, user database 130, application server 135, middleware 140, compliance utility 145, report engine 155, and compliance database 150. With respect to FIG. 2, the system may also include an applicant/purchaser 250, presenting bank 270, beneficiary/seller 280 and carrier 290.

With reference again to FIG. 1, user 105 may include any individual, group of individuals, business, entity, government organization, software and/or hardware that interact with system 100 to apply for a LC, inquire about a LC, monitor activities relating to a particular LC, purchase, lease, rent, sell or exploit items (e.g., goods, services, information, entertainment, packages, commodities, securities, options, derivatives, etc) and/or the like. In one embodiment, user 105 may be a purchasing agent for an organization. In another embodiment, user 105 may be a beneficiary of a LC who interacts with issuing financial institution 160 for the various purposes disclosed herein. User 105 may also comprise a presenting bank and/or a carrier.

Web client 110 comprises any hardware and/or software suitably configured to facilitate input, receipt and/or review of information relating to LC acquisition or any information disclosed herein. Web client 110 includes any device (e.g., personal computer), which communicates (in any manner discussed herein) with issuing financial institution 160 via any network discussed herein. Such browser applications comprise Internet browsing software installed within a computing unit or system to conduct online transactions and communications. These computing units or systems may take the form of a computer or set of computers, although other types of computing units or systems may be used, including laptops, notebooks, hand held computers, set-top boxes, workstations, computer-servers, main frame computers, mini-computers, PC servers, pervasive computers, network sets of computers, and/or the like. Practitioners will appreciate that web client 110 may or may not be in direct contact with case issuing financial institution 160. For example, web client 110 may access the services of case issuing financial institution 160 through another server, which may have a direct or indirect connection to intranet server 120.

Firewall 115, as used herein, may comprise any hardware and/or software suitably configured to protect issuing financial institution 160 components from users of other networks. Firewall 115 may reside in varying configurations including stateful inspection, proxy based and packet filtering, among others. Firewall 115 may be integrated as software within Intranet server 120, any other system components, or may reside within another computing device or may take the form of a standalone hardware component.

Intranet server 120 may include any hardware and/or software suitably configured to facilitate communications between web client 110 and one or more issuing financial institution 160 components. Further, intranet server 120 may be configured to transmit data to web client 110 within markup language documents. As used herein, “data” may include encompassing information such as commands, queries, files, data for storage, and/or the like in digital or any other form. Intranet server 120 may operate as a single entity in a single geographic location or as separate computing components located together or in separate geographic locations.

Application server 135 may include any hardware and/or software suitably configured to serve applications and data to a connected web client 110. Like intranet server 120, application server 135 may communicate with any number of other servers, databases and/or components through any means known in the art. Further, application server 135 may serve as a conduit between web client 110 and the various systems and components of the issuing financial institution 160. Intranet server 120 may interface with application server 135 through any means known in the art including a LAN/WAN, for example. Application server 135 may further invoke Compliance Utility 145 in response to user 105 requests.

Compliance Utility 145 may include any hardware and/or software suitably configured to receive requests from web client 110 via Intranet server 120 and application server 135. Compliance Utility 145 is further configured to process requests, construct database queries, execute queries against compliance database 150, and/or exchange data with any number of brokers 170, credit reporting agencies 160, etc. via middleware 140. In one embodiment, Compliance Utility 145 may be configured to interact with other issuing financial institution 160 components to perform complex calculations, retrieve additional data, format data into reports, create XML representations of data, construct markup language documents, and/or the like. Moreover, Compliance Utility 145 may reside as a standalone system or may be incorporated within application server 135 or any other issuing financial institution 160 component as program code.

The issuing financial institution 160 and the transaction account issuer 160 may be interconnected via middleware 140. Middleware 140 may include any hardware and/or software suitably configured to facilitate communications and/or process transactions between disparate computing systems. Middleware components are commercially available and known in the art. Middleware 140 may be implemented through commercially available hardware and/or software, through custom hardware and/or software components, or through a combination thereof. Middleware 140 may reside in a variety of configurations and may exist as a standalone system or may be a software component residing on the intranet server 120. Middleware 140 may be configured to process transactions between the various components of issuing financial institution 160 and any number of internal or external issuer systems 100 for the purposes disclosed herein. In one embodiment, middleware 140 may comprise web services that are invoked to exchange data between the various disclosed systems.

Issuing financial institution 160 further includes a report engine 155. Report engine 155 includes any hardware and/or software suitably configured to produce reports from information stored in one or more databases. Report engines are commercially available and known in the art. Report engine 155 provides, for example, printed reports, web access to reports, graphs, real-time information, raw data, batch information and/or the like. Report engine 155 may be implemented through commercially available hardware and/or software, through custom hardware and/or software components, or through a combination thereof. Further, report engine 155 may reside as a standalone system within issuing financial institution 160 or as a component of intranet server 120.

In order to control access to application server 135 or any other component of issuing financial institution 160, intranet server 120 may invoke an authentication server 125 in response to user 105 submissions of authentication credentials received at intranet server 120. Authentication server 125 may include any hardware and/or software suitably configured to receive authentication credentials, encrypt and decrypt credentials, authenticate credentials, and/or grant access rights according to pre-defined privileges attached to the credentials. Authentication server 125 may grant varying degrees of application and data level access to users based on information stored within user database 130.

Contrary to the prior art, and with reference to FIG. 2, the present invention guards the financial institution issuing the LC against loss, regardless of market fluctuations, of the items that are the subject of the LC. In one embodiment, applicant (purchaser) 250 submits an application (step 230) for a LC to the issuing financial institution 260 with instructions to hedge the price of the underlying items through a commodity derivative. For example, if the commodity is oil, the issuing financial intuition 260 determines a futures purchase price for the oil commodity in a quantity similar to the number of barrels defined in the LC. Pending review and approval by the issuing financial institution 260, the LC is recorded (step 235) against the applicant's 250 credit limit. The issuing financial institution 260 then transmits (step 220) the LC to a presenting bank 270. Upon receipt of the LC from the issuing financial institution 260, the presenting bank 270 advises (step 225) the LC to the beneficiary (seller) 280. Upon receipt of the LC from the issuing financial institution 250, the presenting bank 270 advises the LC (step 225) to the beneficiary (seller) 280. The presenting bank 270 forwards (step 215) complying documents to the issuing financial institution 260 for payment under the LC. The issuing financial institution 260 pays under the LC for the amount of drawing and the presenting bank 270 pays the proceeds to the beneficiary 280. The applicant 250 pays the issuing financial institution 260 for the amount of the drawing and the issuing financial institution 260 releases documents (including full set B/L) to the applicant 250. The applicant 250 presents the B/L to the carrier 290 for delivery of items (step 240) and the carrier 290 releases the items (step 245) to the applicant 250.

If the applicant 250 fails to pay the issuing financial institution 260 based on the terms of the LC, then the issuing financial institution 260 secures payment from a new buyer for the commodity and any shortfall in the price of the items will be covered by the hedge. The issuing financial institution 260 releases related documents (including the full set B/L) to the new buyer, the new buyer presents the B/L to the carrier 290 to secure delivery of the commodity, and the carrier 290 releases the commodity to the new buyer.

In accordance with an embodiment, the disclosed hedged LC may be subject to its own set of minimum acceptance criteria. Such minimum acceptance criteria may include, for example, control of the underlying items through documents. The LC should call for a full set of original on board B/L conferring to the issuing financial institution 160 the right to possession of items by way of endorsement or consigning to order of the issuing financial institution 160. Further examples of minimum acceptance criteria may include: 1) ensuring that the B/L to be issued by carrier 290 is approved by the issuing financial institution 160, or otherwise approved by the issuing financial institution credit authority; 2) items should be adequately insured, with the issuing financial institution 160 as the loss payee; 3) items should be inspected for quality and quantity by surveyor approved by the issuing financial institution 160, unless otherwise approved by the issuing financial institution credit authority; and 4) the items should be an eligible commodity that can be hedged through commodity derivatives.

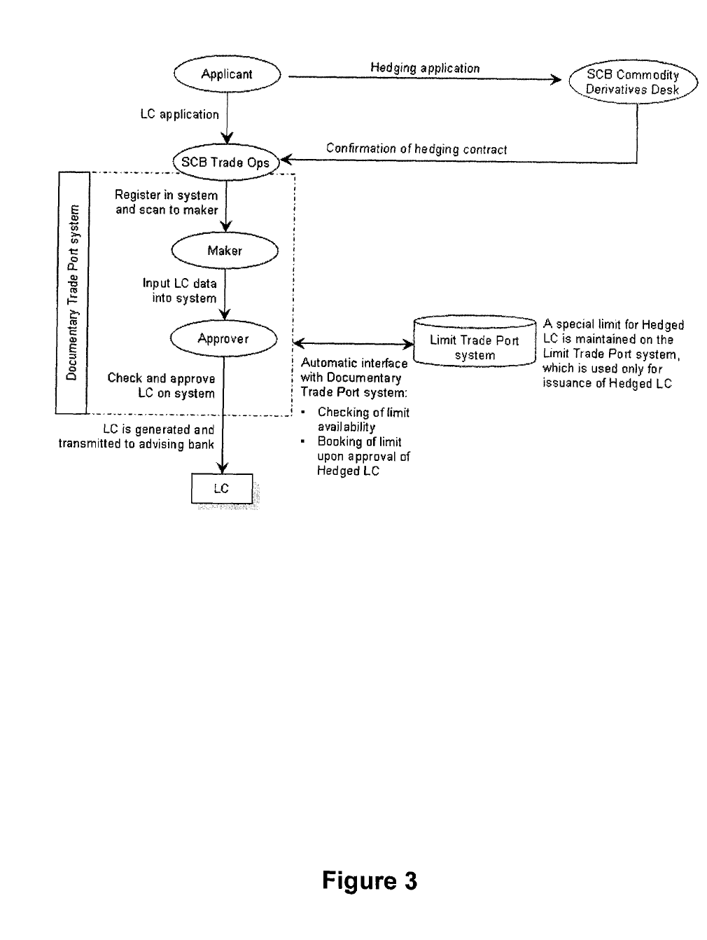

While the above provides an overall description of the processes employed by the present invention, the following relates to hedging of the commodity to reduce price risk to the issuing financial institution, while reducing the line of credit requirements for the applicant. Accordingly, the following discusses the transformation of specific data to an instruction to create a particular type of letter of credit or to issue a specific line of credit. A more specific description of the disclosed commodity hedging process relative to the issuance of LCs can also be found in FIG. 3.

In one embodiment, applicant 250 submits an application for a LC to the issuing financial institution 260 and requests that the commodity that would be subject to the LC be hedged. The issuing financial institution 260 calculates a FSV for the commodity based on a purchase price for the same or similar commodity in a futures market in addition to any other cost associated with the forced sale of the commodity (e.g., storage, transportation, etc.). The issuing financial institution 260 also determines the credit risk associated with the applicant 250 based on any number of factors including credit reports, company financials, and the like. When it is determined that the applicant 250 falls within an acceptable credit risk of the issuing financial institution 260, then the issuing financial institution 260 uses the FSV to establish a required line of credit for the applicant 250. When it is established that the FSV and the line of credit is within an acceptable risk threshold of the issuing financial institution 260, then the issuing financial institution 260 purchases a right to sell a volume of the commodity on the futures market that is roughly equal to the volume of the commodity, which is subject to the LC. As such, the issuing financial institution 260 is protected from possible price fluctuations of the commodity between the time that the LC is issued and when a possible forced sale becomes necessary.

In one embodiment, the purchasing of the right to sell the commodity on the futures market is based on a futures option. In other words, the issuing financial institution 260 does not actually purchase the commodity at the time of LC issuance, but instead reserves the right to sell the commodity should it choose to execute the option. In accordance with this embodiment, the issuing financial institution 260 is not required to sell a purchased commodity when the applicant 250 follows through with the agreement to buy a commodity from the beneficiary 280.

In accordance with this embodiment, the beneficiary places the commodity that is subject to the LC in a futures market and the issuing financial institution 260 purchases the commodity at market value. Therefore, the LC is secured directly based on the commodity that is subject to a purchase agreement between the applicant 250 and the beneficiary 280.

In yet another embodiment, the commodity or commodity option contract may be based on a similar, but not identical commodity. For example, the applicant 250 may apply for a hedged LC for a shipment of a certain quantity of corn. The issuing financial institution 260 may choose to enter into a futures contract for a quantity of wheat to hedge the corn shipment.

Practitioners will appreciate that the above process flow descriptions may be modified without departing from the scope of the invention. The disclosed methods for hedging of a commodity for which a LC is to be issued may be applied in any number of configurations of trade infrastructures. The present invention is directed toward the entire process of offsetting risk to a financial institution through hedging of a commodity, wherein the entire process includes particular elements of processes relating to hedging and LC issuance. The present invention relates to the transformation of data relating to commodity and commodity derivatives, as well as additional information disclosed herein, in order to create a unique LC that is backed by a commodity contract, which guards against future market fluctuations of the commodity subject to the LC.

As will be appreciated by one of ordinary skill in the art, the present invention may be embodied as a customization of an existing system, an add-on product, upgraded software, a stand alone system (e.g., kiosk), a distributed system, a method, a data processing system, a device for data processing, and/or a computer program product. Accordingly, the present invention may take the form of an entirely software embodiment, an entirely hardware embodiment, or an embodiment combining aspects of both software and hardware. Furthermore, the present invention may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

The various system components discussed herein may additionally include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases. Various databases used herein may include: client data; merchant data; financial institution data; and/or like data useful in the operation of the present invention. As those skilled in the art will appreciate, user computer may include an operating system (e.g., Windows NT, 95/98/2000, OS2, UNIX, Linux, Solaris, MacOS, etc.) as well as various conventional support software and drivers typically associated with computers. The computer may include any suitable personal computer, network computer, workstation, minicomputer, mainframe or the like. User computer can be in a home or business environment with access to a network. In an exemplary embodiment, access is through a network or the Internet through a commercially-available web-browser software package.

As used herein, the term “network” shall include any electronic communications means which incorporates both hardware and software components of such. Communication among the parties in accordance with the present invention may be accomplished through any suitable communication channels, such as, for example, a telephone network, an extranet, an intranet, Internet, point of interaction device (point of sale device, personal digital assistant, cellular phone, kiosk, etc.), online communications, satellite communications, off-line communications, wireless communications, transponder communications, local area network (LAN), wide area network (WAN), networked or linked devices, keyboard, mouse and/or any suitable communication or data input modality. Moreover, although the invention is frequently described herein as being implemented with TCP/IP communications protocols, the invention may also be implemented using IPX, Appletalk, IP-6, NetBIOS, OSI or any number of existing or future protocols. If the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein. See, for example, DILIP NAIK, INTERNET STANDARDS AND PROTOCOLS (1998); JAVA 2 COMPLETE, various authors, (Sybex 1999); DEBORAH RAY AND ERIC RAY, MASTERING HTML 4.0 (1997); and LOSHIN, TCP/IP CLEARLY EXPLAINED (1997) and DAVID GOURLEY AND BRIAN TOTTY, HTTP, THE DEFINITIVE GUIDE (2002), the contents of which are hereby incorporated by reference.

The various system components may be independently, separately or collectively suitably coupled to the network via data links which includes, for example, a connection to an Internet Service Provider (ISP) over the local loop as is typically used in connection with standard modem communication, cable modem, Dish networks, ISDN, Digital Subscriber Line (DSL), or various wireless communication methods, see, e.g., GILBERT HELD, UNDERSTANDING DATA COMMUNICATIONS (1996), which is hereby incorporated by reference. It is noted that the network may be implemented as other types of networks, such as an interactive television (ITV) network. Moreover, the system contemplates the use, sale or distribution of any goods, services or information over any network having similar functionality described herein.

As used herein, “transmit” may include sending electronic data from one system component to another over a network connection. Additionally, as used herein, “data” may include encompassing information such as commands, queries, files, data for storage, and the like in digital or any other form.

Any databases discussed herein may be any type of database, such as relational, hierarchical, graphical, object-oriented, and/or other database configurations. Common database products that may be used to implement the databases include DB2 by IBM (White Plains, N.Y.), various database products available from Oracle Corporation (Redwood Shores, Calif.), Microsoft Access or Microsoft SQL Server by Microsoft Corporation (Redmond, Wash.), or any other suitable database product. Moreover, the databases may be organized in any suitable manner, for example, as data tables or lookup tables. Each record may be a single file, a series of files, a linked series of data fields or any other data structure. Association of certain data may be accomplished through any desired data association technique such as those known or practiced in the art. For example, the association may be accomplished either manually or automatically. Automatic association techniques may include, for example, a database search, a database merge, GREP, AGREP, SQL, using a key field in the tables to speed searches, sequential searches through all the tables and files, sorting records in the file according to a known order to simplify lookup, and/or the like. The association step may be accomplished by a database merge function, for example, using a “key field” in pre-selected databases or data sectors.

More particularly, a “key field” partitions the database according to the high-level class of objects defined by the key field. For example, certain types of data may be designated as a key field in a plurality of related data tables and the data tables may then be linked on the basis of the type of data in the key field. The data corresponding to the key field in each of the linked data tables is preferably the same or of the same type. However, data tables having similar, though not identical, data in the key fields may also be linked by using AGREP, for example. In accordance with one aspect of the present invention, any suitable data storage technique may be utilized to store data without a standard format. Data sets may be stored using any suitable technique, including, for example, storing individual files using an ISO/IEC 7816-4 file structure; implementing a domain whereby a dedicated file is selected that exposes one or more elementary files containing one or more data sets; using data sets stored in individual files using a hierarchical filing system; data sets stored as records in a single file (including compression, SQL accessible, hashed via one or more keys, numeric, alphabetical by first tuple, etc.); Binary Large Object (BLOB); stored as ungrouped data elements encoded using ISO/IEC 7816-6 data elements; stored as ungrouped data elements encoded using ISO/IEC Abstract Syntax Notation (ASN.1) as in ISO/IEC 8824 and 8825; other proprietary techniques that may include fractal compression methods, image compression methods, etc.

In one exemplary embodiment, the ability to store a wide variety of information in different formats is facilitated by storing the information as a BLOB. Thus, any binary information can be stored in a storage space associated with a data set. As discussed above, the binary information may be stored on the financial transaction instrument or external to but affiliated with the financial transaction instrument. The BLOB method may store data sets as ungrouped data elements formatted as a block of binary via a fixed memory offset using fixed storage allocation, circular queue techniques, or best practices with respect to memory management (e.g., paged memory, least recently used, etc.). By using BLOB methods, the ability to store various data sets that have different formats facilitates the storage of data associated with the financial transaction instrument by multiple and unrelated owners of the data sets. For example, a first data set which may be stored may be provided by a first party, a second data set which may be stored may be provided by an unrelated second party, and yet a third data set which may be stored, may be provided by an third party unrelated to the first and second party. Each of these three exemplary data sets may contain different information that is stored using different data storage formats and/or techniques. Further, each data set may contain subsets of data that also may be distinct from other subsets.

As stated above, in various embodiments of the present invention, the data can be stored without regard to a common format. However, in one exemplary embodiment of the present invention, the data set (e.g., BLOB) may be annotated in a standard manner when provided for manipulating the data onto the financial transaction instrument. The annotation may comprise a short header, trailer, or other appropriate indicator related to each data set that is configured to convey information useful in managing the various data sets. For example, the annotation may be called a “condition header”, “header”, “trailer”, or “status”, herein, and may comprise an indication of the status of the data set or may include an identifier correlated to a specific issuer or owner of the data. In one example, the first three bytes of each data set BLOB may be configured or configurable to indicate the status of that particular data set; e.g., LOADED, INITIALIZED, READY, BLOCKED, REMOVABLE, or DELETED. Subsequent bytes of data may be used to indicate for example, the identity of the issuer, user, transaction/membership account identifier or the like. Each of these condition annotations are further discussed herein.

The data set annotation may also be used for other types of status information as well as various other purposes. For example, the data set annotation may include security information establishing access levels. The access levels may, for example, be configured to permit only certain individuals, levels of employees, companies, or other entities to access data sets, or to permit access to specific data sets based on the transaction, merchant, issuer, user or the like. Furthermore, the security information may restrict/permit only certain actions such as accessing, modifying, and/or deleting data sets. In one example, the data set annotation indicates that only the data set owner or the user are permitted to delete a data set, various identified users may be permitted to access the data set for reading, and others are altogether excluded from accessing the data set. However, other access restriction parameters may also be used allowing various entities to access a data set with various permission levels as appropriate.

The data, including the header or trailer may be received by a stand alone interaction device configured to add, delete, modify, or augment the data in accordance with the header or trailer. As such, in one embodiment, the header or trailer is not stored on the transaction device along with the associated issuer-owned data but instead the appropriate action may be taken by providing to the transaction instrument user at the stand alone device, the appropriate option for the action to be taken. The present invention may contemplate a data storage arrangement wherein the header or trailer, or header or trailer history, of the data is stored on the transaction instrument in relation to the appropriate data.

One skilled in the art will also appreciate that, for security reasons, any databases, systems, devices, servers or other components of the present invention may consist of any combination thereof at a single location or at multiple locations, wherein each database or system includes any of various suitable security features, such as firewalls, access codes, encryption, decryption, compression, decompression, and/or the like.

The computers discussed herein may provide a suitable web site or other Internet-based graphical user interface which is accessible by users. In one embodiment, the Microsoft Internet Information Server (IIS), Microsoft Transaction Server (MTS), and Microsoft SQL Server, are used in conjunction with the Microsoft operating system, Microsoft NT web server software, a Microsoft SQL Server database system, and a Microsoft Commerce Server. Additionally, components such as Access or Microsoft SQL Server, Oracle, Sybase, Informix MySQL, Interbase, etc., may be used to provide an Active Data Object (ADO) compliant database management system.

Any of the communications, inputs, storage, databases or displays discussed herein may be facilitated through a web site having web pages. The term “web page” as it is used herein is not meant to limit the type of documents and applications that might be used to interact with the user. For example, a typical web site might include, in addition to standard HTML documents, various forms, Java applets, JavaScript, active server pages (ASP), common gateway interface scripts (CGI), extensible markup language (XML), dynamic HTML, cascading style sheets (CSS), helper applications, plug-ins, and the like. A server may include a web service that receives a request from a web server, the request including a URL (http://yahoo.com/stockquotes/ge) and an IP address (123.56.789). The web server retrieves the appropriate web pages and sends the data or applications for the web pages to the IP address. Web services are applications that are capable of interacting with other applications over a communications means, such as the internet. Web services are typically based on standards or protocols such as XML, SOAP, WSDL and UDDI. Web services methods are well known in the art, and are covered in many standard texts. See, e.g., ALEX NGHIEM, IT WEB SERVICES: A ROADMAP FOR THE ENTERPRISE (2003), hereby incorporated by reference.

The present invention may be described herein in terms of functional block components, screen shots, optional selections and various processing steps. It should be appreciated that such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices. Similarly, the software elements of the present invention may be implemented with any programming or scripting language such as C, C++, Java, COBOL, assembler, PERL, Visual Basic, SQL Stored Procedures, extensible markup language (XML), with the various algorithms being implemented with any combination of data structures, objects, processes, routines or other programming elements. Further, it should be noted that the present invention may employ any number of conventional techniques for data transmission, signaling, data processing, network control, and the like. Still further, the invention could be used to detect or prevent security issues with a client-side scripting language, such as JavaScript, VBScript or the like. For a basic introduction of cryptography and network security, see any of the following references: (1) “Applied Cryptography: Protocols, Algorithms, And Source Code In C,” by Bruce Schneier, published by John Wiley & Sons (second edition, 1995); (2) “Java Cryptography” by Jonathan Knudson, published by O'Reilly & Associates (1998); (3) “Cryptography & Network Security: Principles & Practice” by William Stallings, published by Prentice Hall; all of which are hereby incorporated by reference.

As will be appreciated by one of ordinary skill in the art, the present invention may be embodied as a customization of an existing system, an add-on product, upgraded software, a stand alone system, a distributed system, a method, a data processing system, a device for data processing, and/or a computer program product. Accordingly, the present invention may take the form of an entirely software embodiment, an entirely hardware embodiment, or an embodiment combining aspects of both software and hardware. Furthermore, the present invention may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

Computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the invention. The scope of the invention is accordingly to be limited by nothing other than the appended claims, in which reference to an element in the singular is not intended to mean “one and only one” unless explicitly so stated, but rather “one or more.” Moreover, where a phrase similar to ‘at least one of A, B, or C’ is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Although the invention has been described as a method, it is contemplated that it may be embodied as computer program instructions on a tangible computer-readable carrier, such as a magnetic or optical memory or a magnetic or optical disk. All structural, chemical, and functional equivalents to the elements of the above-described exemplary embodiments that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

We claim:

1. A method for an issuing bank to transform a hedge, credit risk information and a forced sale value (FSV) into a special Letter of Credit (LC) for facilitating a purchase of a commodity, comprising:
determining, by the issuing bank computer, a credit risk of the applicant;
determining, by the issuing bank computer, the credit risk is within an acceptable range;
determining, by the issuing bank computer, a FSV based upon a purchase price of a similar commodity in a futures market and costs associated with a forced sale of the commodity;
determining, by the issuing bank computer, the FSV is within an acceptable range;
establishing, by the issuing bank computer, a line of credit for the applicant based upon the credit risk and FSV;
establishing, by the issuing bank computer, a hedge of the commodity using a commodity derivative, which includes a right to sell the commodity on the futures market to reduce price risk;
transforming, by the issuing bank computer, a letter of credit into the special LC based upon the hedge, the FSV and the credit risk;
transforming, by the issuing bank computer, the applicant's booked credit limit to a reduced booked credit limit;
transforming, by the issuing bank computer, the applicant's risk weighted asset (RWA) to a reduced RWA; and,
issuing, by the issuing bank computer, the special LC to the applicant for facilitating the purchase of the commodity.

2. The method of claim 1, further comprising receiving, from the applicant, an application for the LC, wherein the application includes instructions to hedge the price of the underlying commodity through a commodity derivative.

3. The method of claim 1, further comprising recording the LC against the credit limit of the applicant in response to approving the application to create a drawing for the LC.

4. The method of claim 1, further comprising:
transmitting the LC to a presenting bank, wherein the presenting bank presents the LC to a beneficiary;
receiving complying documents from the presenting bank for payment under the LC;
issuing payment under the LC for an amount of the drawing to the presenting bank, wherein the presenting bank issues proceeds to the beneficiary; and,
securing payment for the underlying commodity through a sell of the underlying commodity to a new buyer in response to the applicant failing to pay the amount of the drawing.

5. The method of claim 1, wherein the underlying commodity is secured through a Bill of Lading (B/L).

6. The method of claim 5, further comprising releasing the B/L to the applicant upon receipt of proceeds in an amount of the drawing.

7. The method of claim 6, wherein the applicant presents the B/L to the carrier of the underlying commodity upon delivery to obtain legal possession of the underlying commodity.

8. The method of claim 1, wherein a shortfall in a forced sale of the underlying commodity is recovered through the hedge.

9. The method of claim 1, further comprising releasing legal documents to the new buyer in response to the applicant failing to pay the amount of the drawing.

10. The method of claim 1, wherein the LC is subject to minimum acceptance criteria, wherein the minimum acceptance criteria includes at least one of: control of the underlying commodity through documents, approval of a Bill of Lading (B/L), insurance of the underlying commodity, inspection of the underlying commodity by a surveyor approved by an issuer of the LC, the underlying commodity being eligible for hedging through the commodity derivatives.

11. An issuing bank computer configured to transform a hedge, credit risk information and a forced sale value (FSV) into a special Letter of Credit (LC) for facilitating a purchase of a commodity, the issuing bank computer configured to:
determine a credit risk of the applicant;
determine the credit risk is within an acceptable range;
determine a FSV based upon a purchase price of a similar commodity in a futures market and costs associated with a forced sale of the commodity;
determine the FSV is within an acceptable range;
establish a line of credit for the applicant based upon the credit risk and FSV;
establish a hedge of the commodity using a commodity derivative, which includes a right to sell the commodity on the futures market to reduce price risk;
transform a letter of credit into the special LC based upon the hedge, the FSV and the credit risk;
transform the applicant's booked credit limit to a reduced booked credit limit;
transform the applicant's risk weighted asset (RWA) to a reduced RWA; and,
issue the special LC to the applicant for facilitating the purchase of the commodity.

12. A computer-readable medium having stored thereon a plurality of instructions, the plurality of instructions to transform a hedge, credit risk information and a forced sale value (FSV) into a special Letter of Credit (LC) for facilitating a purchase of a commodity, comprising:
instructions to determine a credit risk of the applicant;
instructions to determine the credit risk is within an acceptable range;
instructions to determine a FSV based upon a purchase price of a similar commodity in a futures market and costs associated with a forced sale of the commodity;
instructions to determine the FSV is within an acceptable range;
instructions to establish a line of credit for the applicant based upon the credit risk and FSV;
instructions to establish a hedge of the commodity using a commodity derivative, which includes a right to sell the commodity on the futures market to reduce price risk;
instructions to transform a letter of credit into the special LC based upon the hedge, the FSV and the credit risk;
instructions to transform the applicant's booked credit limit to a reduced booked credit limit;
instructions to transform the applicant's risk weighted asset (RWA) to a reduced RWA; and,
instructions to issue the special LC to the applicant for facilitating the purchase of the commodity.

13. The method of claim 1, wherein the determining a credit risk of the applicant further comprises retrieving reputation information from a database.

14. The method of claim 1, wherein the determining that the credit risk is within an acceptable range further comprises performing a calculation based on information retrieved from a database relating to at least one of: reputation and predetermined risk analysis.

15. The method of claim 1, wherein the determining a FSV based upon a purchase price of a similar commodity is based on market prices retrieved from a database.

16. The method of claim 1, wherein the determining the FSV is within an acceptable range further comprises retrieving predefined acceptance criteria from a database.

17. The method of claim 1, wherein the establishing a line of credit for the applicant further comprises retrieving at least one of: predefined acceptance criteria or reputation information from a database.

18. The method of claim 1, wherein the establishing a hedge of the commodity further comprises retrieving commodity derivative information from a database.

19. The method of claim 1, wherein the transforming the applicant's booked credit limit to a reduced booked credit limit is determined from on an offset calculated from values retrieved from a database.

20. The method of claim 1, wherein the transforming the applicant's risk weighted asset (RWA) to a reduced RWA is determined from values retrieved from a database.

21. The method of claim 1, wherein the issuing the special LC to the applicant is performed over a computerized network.
